(19) United States
(12) Patent Application Publication
(10) Pub. No.: US 2002/0193715 A1
(43) Pub. Date: Dec. 19, 2002

(54) Accu-massager

(76) Inventor: Brian G. Slack, Peterborough (CA)

Correspondence Address: Brian G. Slack, 506 Sherbrooke St., #3, Peterborough, ON, K9J2P3, CA

(21) Appl. No.: 09/882,336

(22) Filed: Jun. 18, 2001

(51) Int. Cl. A61H 7/00

(52) U.S. Cl. 601/134

(57) ABSTRACT

This is a device to aid in self-massage of the regions of the back, which are inaccessible through self-massage using hands alone. This invention is comprised of a hardwood ball, which locks along a vertical plane to allow precise positioning for accurate, pressure massage. While previous devices designed for self-massage demanded use of the hands and muscles of the shoulders and back, this device allows hands-free self-massage. The device is wall-mounted at a height optimal to the user, enabling him or her to stand or sit and press their back against the ball, thereby, applying therapeutic pressure to relieve tension in the back, shoulders and neck.

### STATEMENT REGARDING FEDERALLY SPONSORED RESEARCH OR DEVELOPMENT

Not Applicable.

### CROSS-REFERENCE TO RELATED APPLICATIONS

Not Applicable.

### REFERENCE TO A MICROFICHE APPENDIX

Not Applicable.

### BACKGROUND TO THE INVENTION

This invention is a manually adjustable, wall-mounted tool for accurate, self, back and shoulder massage.

Devices commonly used in self back-massage tend to be held in the hands and pulled to the place of tension. It is intended that these devices would allow the self-massager to direct the point of massage by moving the hand-held device and pulling with the arms and shoulders on the problem point in the back. Tools of this type are ineffective because the muscles they are designed to help relax are actually involved in the massaging process.

The Accu-massager allows the self-massager to relax the back and shoulders, at the same time, applying body weight to the massage point on their back, while the actual device is firmly secured on a wall mount.

### BRIEF SUMMARY OF THE INVENTION

This is a device to aid in self-massage of the regions of the back, which are inaccessible through self-massage using hands alone. The Accu-massager is comprised of a hardwood ball, which locks onto a flat, steel bar, along a vertical plane to allow precise positioning for accurate pressure massage. The device is wall-mounted at a height optimal to the user, enabling him or her to stand or sit and press their back against the ball, thereby, applying therapeutic pressure to relieve tension in the back. The person wishing to receive the self-massage adjusts the wooden massage ball, vertically, to the desired position. He or she then leans onto the massage ball, applying their weight. This action is similar to many techniques found in traditional massage practices, which formally demanded a separate therapist from the person receiving the massage.

### BRIEF DESCRIPTION OF THE SEVERAL VIEWS OF THE DRAWING

FIG. 1—Accu-massager: Front View

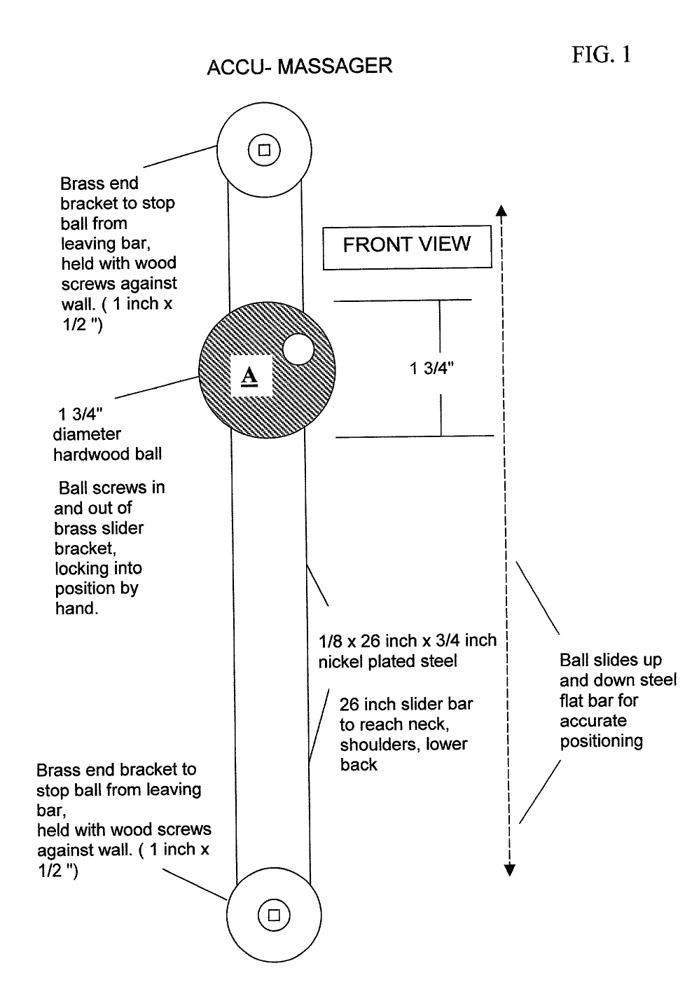

FIG. 2—Accu-massager: Side View (Cross Section)

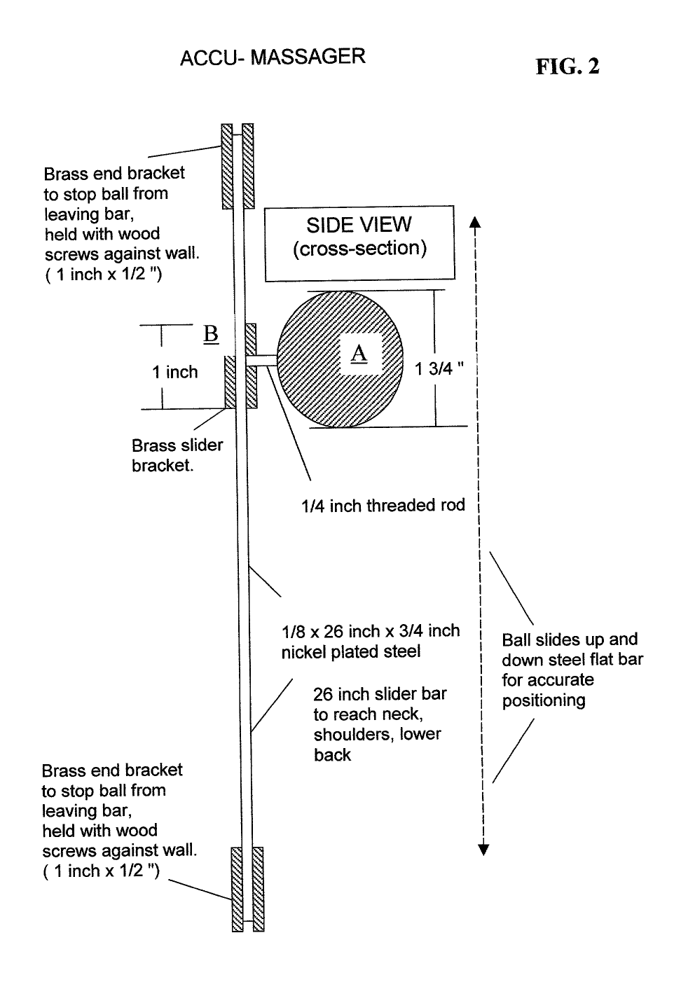

FIG. 3—Accu-massager: Side View

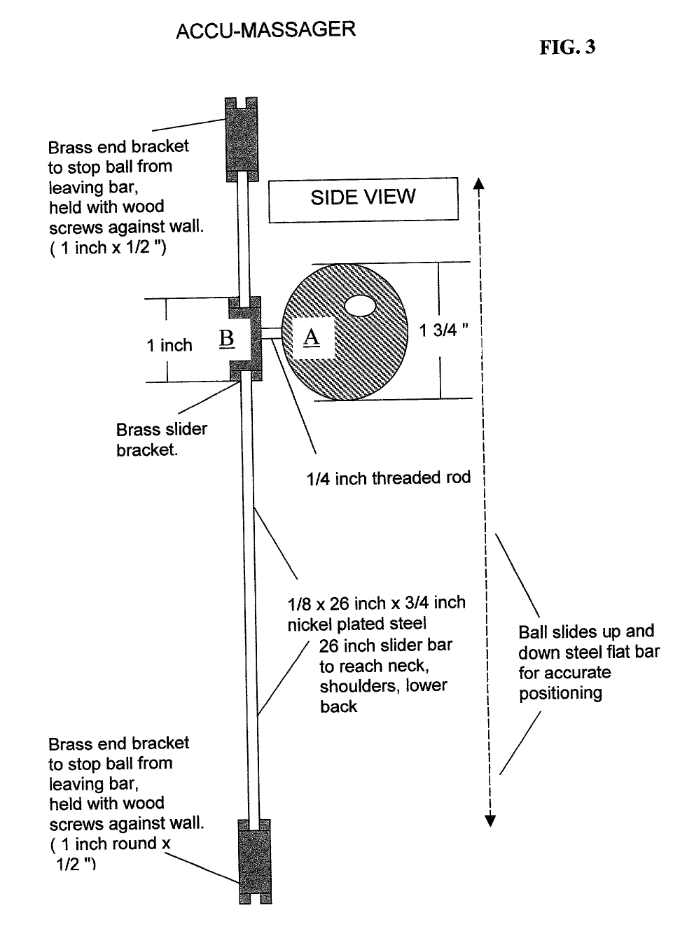

### DETAILED DESCRIPTION OF THE INVENTION

The Accu-massager is a device to aid in self-massage of the regions of the back, shoulders and neck, which are inaccessible through self-massage using hands alone. The Accu-massager is comprised of a hardwood ball “A”, which locks onto a flat, steel bar, through a brass slider bracket “B”, along a vertical plane to allow precise positioning for accurate pressure massage. The person using the device decides at which height they wish to massage and then unlock the wooden massage ball by turning it counter clockwise. To lock it at the desired height, they turn the wooden massage ball clockwise until locked against the steel flat bar. The device is wall-mounted at a height optimal to the user, enabling him or her to stand or sit and press their back against the ball, thereby, applying therapeutic pressure to relieve tension in the back. He or she then leans onto the massage ball, applying their weight. This action is similar to many techniques found in traditional massage practices, which formally demanded a separate therapist from the person receiving the massage.

The device is fabricated using the following components. Brass attachments hold the unit against the wall and stop the massage ball from sliding off. Another brass bracket, the slider “B”, holds the massager ball “A” and allows the ball to be moved, vertically into position and locked in place. These brass hardware pieces are fabricated using a screw machine. The raw material is round bar brass.

The hardwood massage ball is lathed to 1¾ inches in diameter and drilled to accommodate a ¼″ threaded rod. The ball slides vertically on a piece of ¾″ by ⅛″ flat bar steel. This steel is drilled at both ends to hold the brass stoppers and allow wood screws to hold the device on a wall. It is made 26 inches long to facilitate the ball reaching the lower and upper regions of the back and neck. The steel is nickel plated.

1. What I claim as my invention is a wall-mounted, manually operable tool for self-administered, hands-free back massage:
This invention comprises a flat, vertical bar of steel, upon which slides vertically, a bracket-mounted, wooden massage ball, adapted to screw lock at the appropriate height to allow accurate self-massage of the muscles of the back, shoulders and neck.
